(19) United States
(12) Patent Application Publication
(10) Pub. No.: US 2007/0027705 A1
(43) Pub. Date: Feb. 1, 2007

(54) Method for the valuation of intellectual property rights

(76) Inventors: Christian Ginzel, Rimpar (DE); Benedikt Neuburger, Munich (DE)

Correspondence Address: PATTERSON & SHERIDAN, L.L.P., 3040 POST OAK BOULEVARD, SUITE 1500, HOUSTON, TX, 77056, US

(21) Appl. No.: 11/193,563

(22) Filed: Jul. 29, 2005

(51) Int. Cl. G06Q 99/00

(52) U.S. Cl. 705/1

(57) ABSTRACT

A method for valuating an intellectual property right or an intellectual property right application includes providing the intellectual property right or the application therefor claiming a subject matter, identifying at least one essential attribute of the subject matter, undertaking a market analysis on the demand for the at least one essential attribute and deriving a value from the results of the market analysis, whereby the situation of having the intellectual property right or application is compared with the situation of not having it. The essential attribute is the one that generates an added value for consumers buying the related product when compared to products from the state of the art. Decompositional market analysis methods such as Conjoint Analysis and the like are preferred. As a result of the market analysis, a utility value distribution is determined and the maximum of a price-profit function of the essential attribute(s) is calculated.

### BACKGROUND OF THE INVENTION

1. Field of the Invention

This invention relates to a method for the valuation of intellectual property rights or intellectual property right applications.

2. Description of the Related Art

Intellectual property rights (IPR) are of vital importance for companies in many sectors such as automotive, telecommunications, semiconductor, software, chemistry, pharmacy and so on. The necessity to estimate the value of an intellectual property right or an intellectual property right application (IPRoA) may arise due to different economic reasons: transaction support sale; licensing; strategic alliances; infringement damages; collateral-based, debt capital-based or equity capital-based financing; attorney malpractice; bankruptcy of an enterprise; taking out a policy on the IPR etc. Furthermore, the necessity for the valuation may arise due to legal and tax requirements: determining estate, gift or ad valorem taxes; intercompany transactions; regulatory requirements for initial public offering etc. Regarding the accounting of IPRs, according to the Statement of Financial Accounting Standard (SFAS) 142.9, intangible assets such as IPRs, that are acquired either separately or in the framework of an enterprise purchase/merger, have to be capitalized with their fair value which can be roughly understood as a market value (compare SFAS 142.24). In the subsequent years, the necessity to value the purchased IPRs may arise within the framework of an impairment test.

Roughly summarized, the methods known in the art for estimating the value of IPRoA can be segmented into four categories.

Cost oriented methods calculate the costs accrued from making and applying the invention such as Research & Development costs, patent attorney and PTO fees. Cost oriented methods, however, have little in common with an economic understanding of the IPRoA value as they do not map future revenues resulting from the patent. Hence, those methods may be simple to apply, but their results are not of any value.

Profit or cash flow oriented methods aim at calculating the present value of the future profits or cash flow resulting from the IPRoA. These methods are mainly concerned with determining an adequate discount rate with future risks being most commonly accounted for in said discount rate. However, profit and cash flow oriented methods do not give any methodical assistance as to how those future profits or cash flows can be estimated. Most commonly, they are estimated by way of extrapolating the profits or cash flows of the last years, or by asking some experts for their opinion. That is, particularly in the case of an IPRoA that is related to a product not yet brought to market, the application of profit or cash flow oriented methods needs further methodical support.

The several market oriented methods have in common that they are based on values which are taken from an active market. Hence, it is assumed that these values are a result of free trading of fully informed market participants, thus giving an IPRoA value fitting perfectly to the economic understanding of a value. The most popular example for a market oriented method is license analogy method which calculates an amount that a licensee would pay for the right to use the invention protected by the IPRoA. Normally, the license rate is taken from recommendations given in the literature, or from corporate documents. However, as uniqueness is one of the most characteristic natures of an IPRoA, these methods suffer from low comparability with other IPRs. Furthermore, when determining the resulting value of an IPRoA, the sales of the IPRoA related product have to be forecasted. This task, however, is not solved by the license analogy method.

Lately, many researchers try to give an estimation of an IPRoA by simply accounting for so-called indicators. Such indicators are, for instance, the number of inventors, the multinationality of the inventors, the number of later IPRoA citing the IPRoA to be valued, the fact whether the IPR has been subject to an opposition or litigation etc. There have been studies showing some relationship between indicator values and the value of the patent. However, these methods do not consider the specific circumstances of the IPRoA, in particular, they do not consider the technical teaching and the market success of an IPRoA related product. Hence, these methods can only be applied with large patent portfolios where the law of large numbers cures such coarse approaches.

In summation, the methods known in the state of the art for valuating an IPRoA exhibit many deficiencies.

The present invention aims at providing a method for assigning a value to an IPRoA wherein the value assigned is rather exact and matches perfectly with an economic understanding of the IPRoA value. According to an economic understanding, the future profits realized by an IPRoA correspond to its value. The present invention provides a method for reliably estimating the future profits stemming from the IPRoA.

It is one advantage of the present invention that substantial determinants of the IPRoA value are determined in an appropriate and quite exact method without the need for estimating licensing rates. Thereby, both the technical aspects of the IPRoA and the market demand aspects are taken into consideration. The invention is especially advantageous in that it determines a market value for the IPRoA although in many cases there is no market for the IPRoA. It is a further advantage of the present invention that the information on the market demand is the most up-to-date information. It is a further advantage of the present invention that the valuation can be undertaken by any third party which does not have any internal information on the IPRoA. The present invention is furthermore advantageous as several IPRoAs of related art or an enterprise patent portfolio can be jointly valuated.

Further objects and advantages of the present invention will become apparent from the consideration of the drawings and ensuing description.

### SUMMARY OF THE INVENTION

According to another aspect of the present invention, the present invention provides a method for valuating an intellectual property right or an intellectual property right application comprising the steps of:
providing the intellectual property right or intellectual property right application, the intellectual property right or intellectual property right application claiming a subject matter;
identifying at least one essential attribute of the subject matter;
undertaking a market analysis on the demand for the at least one essential attribute of the subject matter, thereby obtaining market analysis results; and
deriving a value of the intellectual property right or intellectual property right application by evaluating the market analysis results, whereby the situation of having the intellectual property right or intellectual property right application is compared with the situation of not having the intellectual property right or intellectual property right application.

According to typical embodiments, the IPRoA is a patent, a utility patent, or an application for a patent. Typically, the at least one essential attribute of the subject matter is the one that generates an added value for consumers buying the IPRoA related product when compared to products from the state of the art. Methods can also be subject matter of the IPRoA and object of the subsequent market analysis. In many embodiments, decompositional market analysis methods such as Conjoint Analysis and the like are preferred. In this case, the at least one essential attribute of the IPRoA subject matter is mapped into at least one option of at least one Conjoint Analysis attribute. Typically, as result of the market analysis, a utility value distribution is determined. When deriving an IPRoA value, according to a typical embodiment, the maximum of a price-profit function on the at least one essential attribute of the IPRoA subject matter is calculated. According to one embodiment, the future profits can be discounted adequately thus calculating the present value of future profits. Future benefits, such as profit or the like, that result from the protection of the subject matter of the IPRoA, are determined by performing a market research addressing the IPRoA's at least one essential attribute that stand out from the state of the art.

According to another aspect of the present invention, a method for valuating a set of intellectual property rights and/or intellectual property right applications is provided. The set can be a corporate IPR portfolio or a part thereof.

### BRIEF DESCRIPTION OF THE DRAWINGS

FIG. 1 shows the steps for valuating an IPRoA according to the present invention;

FIG. 2 shows the general concept for IPRoA valuation according to the present invention.

FIG. 3 shows an embodiment of the steps for identifying at least one essential attribute of the invention according to the present invention;

FIG. 4 shows an embodiment of the steps for undertaking a market research according to the present invention;

FIG. 5 shows an embodiment of the steps for deriving a value of the IPRoA according to the present invention;

FIG. 6-A shows an exemplary individual price-response function according to an embodiment of the present invention;

FIG. 6-B shows an exemplary aggregated price-response function according to an embodiment of the present invention;

FIG. 7-A shows another exemplary aggregated price-response function according to an embodiment of the present invention;

FIG. 7-B shows an exemplary price-profit function according to an embodiment of the present invention;

FIG. 8 shows an exemplary stimulus of an exemplary Conjoint Analysis for valuating a fictitious patent according to a method embodiment of the present invention; and

FIG. 9 shows three different utilities determined in an exemplary market analysis.

### DETAILED DESCRIPTION

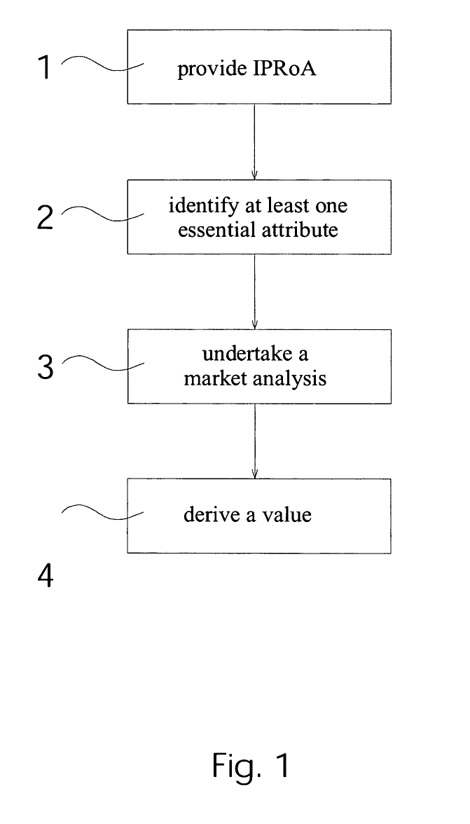

FIG. 1 shows four steps for the valuation of an IPRoA. According to step 1, an IPRoA is provided. The IPRoA can be a patent, a pending patent application, a utility model, a design model etc. In the following, for convenience, the IPRoA is assumed to be a granted patent. The granted patent comprises at least one independent claim, e.g. an apparatus and/or a method claim. The claim is directed to the subject matter of the invention protected by the patent.

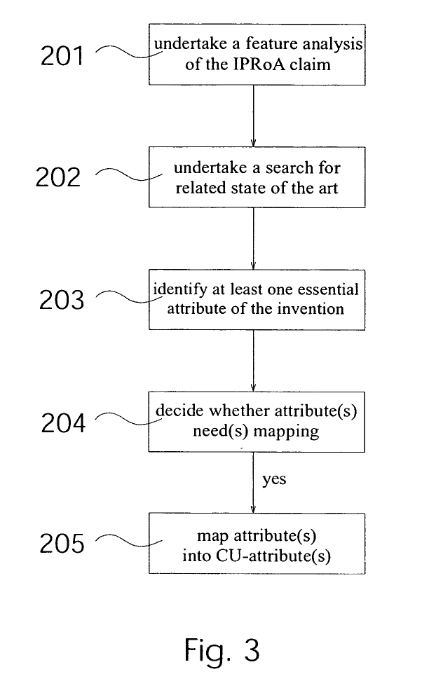

According to step 2 of the present invention, at least one essential attribute of the subject matter of the patent is identified. The essential attribute of the invention is, roughly spoken, an aspect of the invention which generates an added value for the consumers of the invention related product. The at least one essential attributes may be one or more essential features of the subject matter. However, the at least one essential attributes may also be a function of the subject matter or an advantageous effect resulting from the subject matter of the invention. Examples for essential attributes will be given below with respect to FIGS. 3-9. A typical embodiment of step 2 will be described below with respect to FIG. 3.

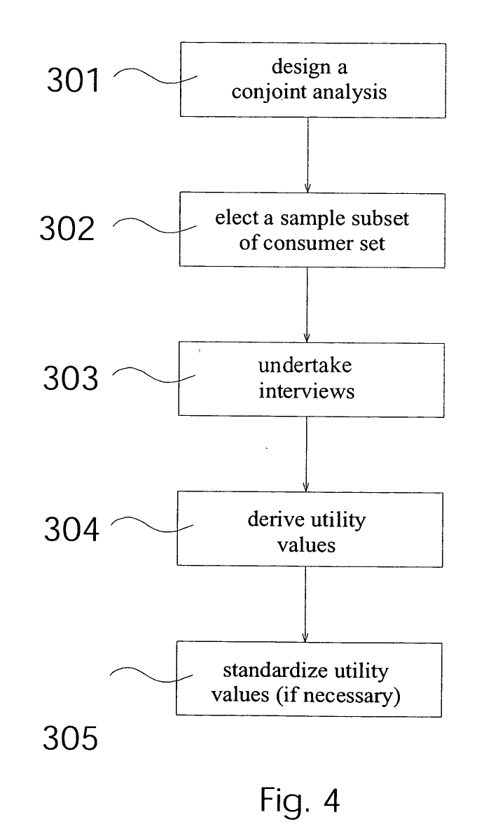

In a further step 3, a market analysis is undertaken. The market analysis addresses, inter alias, the at least one essential attribute of the claimed subject matter as identified in step 2. The market to be analyzed is the product or method market. That is, the people to be interrogated belong to the set of people who could be interested in purchasing the patent related product or method. Typically, these people are not interested in purchasing the patent itself. For example, the market analysis could be undertaken by presenting several alternatives to relevant consumers and asking them for their preferences. At least one of the alternatives relates to the at least one essential attribute of the subject matter. A typical embodiment of step 3 will be described below with respect to FIG. 4.

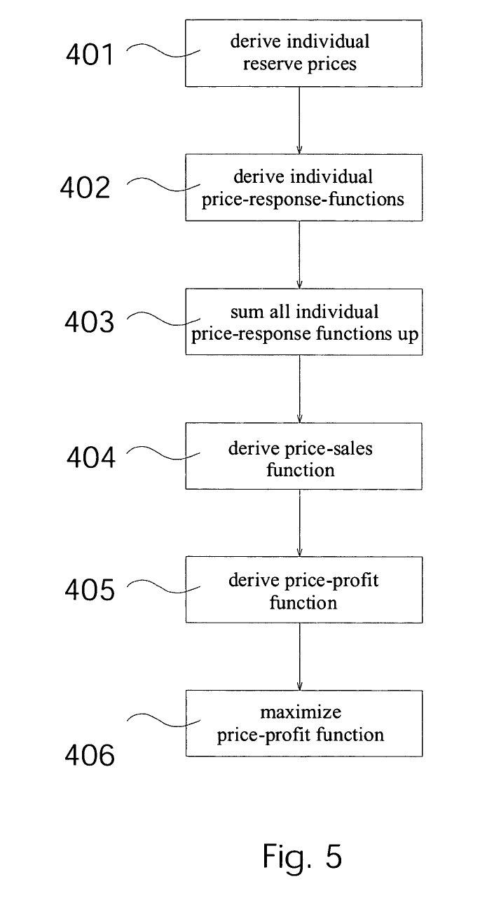

From the results of the market analysis, a value of the patent is derived in step 4 of FIG. 1. In principle, by evaluating the market analysis results, the future benefits stemming from the unique selling position, which is caused by the IPRoA protection, are estimated. Future benefits are e.g. future profits, cash flows, return on investments etc. and stem from selling—to the exclusion of competitors—the IPRoA related product or method to the respective consumers. The following two situations are compared: In one situation, it is assumed to be the holder of the valid IPRoA. In this case, the holder can earn the calculated future benefits. Another situation is not to have the IPRoA. For instance, a competitor could hold the IPRoA. In this case, the market entry in the related market is forbidden for non-IPRoA holder. Alternatively, the IPRoA could have already elapsed, or the IPRoA could have been cancelled. In this case, free competition will evolve causing prices to go down. A typical embodiment of step 4 will be described below with respect to FIG. 5.

If the IPRoA is a patent, utility patent or the like, it should be checked whether it is still valid. If the IPRoA is an application, the valuation as described below can be performed. However, typically in view of a first, or a first and second office action, a probability of grant can be assigned to the application by e.g. a patent attorney. The probability of grant is multiplied with the value of the application calculated by the method according to the present invention described herein. Accordingly, a multiplication with a probability of maintenance may be applied in the case of an IPR which is object to a re-examination, litigation, opposition or nility action or the like at the time it is valuated.

For the purpose of clearness, a short example of an IPRoA valuation according to the invention will be given. This is to be understood as an example of how the present invention can be applied to the valuation of an IPRoA, and it is not limiting the present invention to this specific example. Let the IPRoA to be valuated be a patent on a plate having a slot at one circumferential position in order to place the handle of a wine glass (step 1). Such a plate may be very advantageous for cocktail and Hors d'Oeuvres receptions. Hence, the subject matter of the patent is a plate with said slot. The essential attribute of the subject matter may be identified as the slot in the plate. Alternatively, one could define the essential attribute of the subject matter as the possibility to removably fasten a glass to the plate (step 2). The market analysis could be a survey asking hoteliers on how much they would additionally pay in order to get the slotted plate instead of a common plate (step 3). More subtle market analysis methods will be described below. From the results of this survey, the optimum sales price for the slotted plates and the achievable profit, which solely stems from the slot property, is calculated. This relates to the situation of ownership of the patent. With a competitor holding the patent and not licensing its technology, it is forbidden to sell those plates for the others. Hence, in this situation, no profits from the slotted plates can be earned. Consequently, in this example, the value of the patent is the calculated profit that stems from the earnings caused solely by the utility of the existence of the slots (step 4). As will be clear below, however, the present invention provides a range of very subtle methods for each of the steps described. Depending on the valuation situation and the exactness needed, the applicant of the method according to the present invention can choose between the several methods provided.

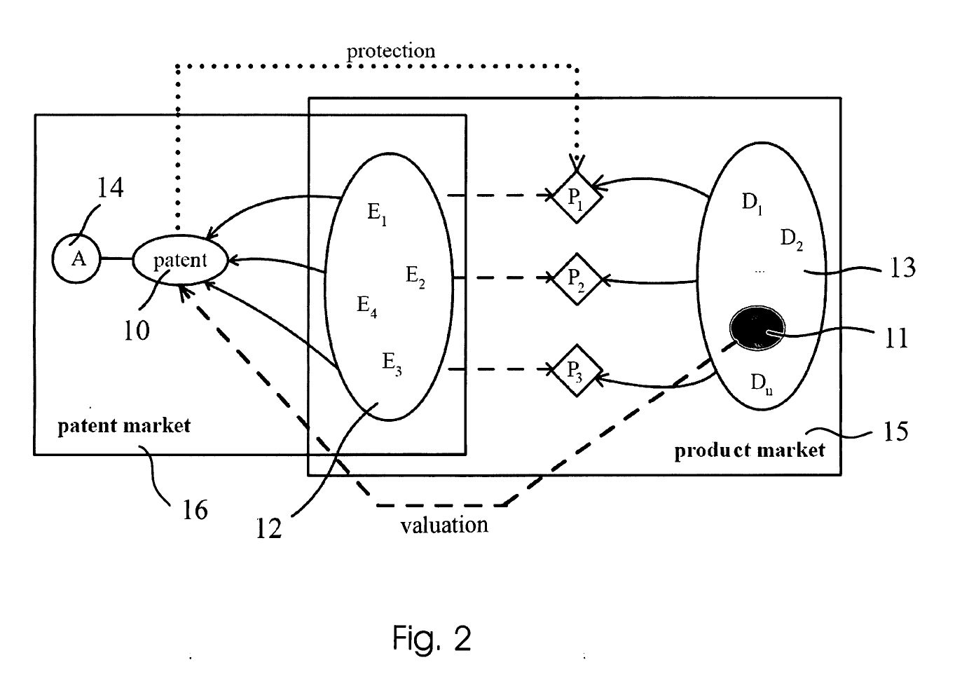

FIG. 2 shows the general concept for IPRoA valuation according to the present invention. The IPRoA to be valued is a patent 10. The subject matter of patent 10 is directed to an invention which has at least one essential attribute which is incorporated in product P₁. Thus, patent 10 protects product P₁ and product P₁ offers some added value for the consumers in comparison to concurring products P₂, P₃. The latter products are similar to product P₁ but not identical. In an alternative embodiment, P₁, P₂, and P₃ are methods. Hence, products P₁, P₂, and P₃ form the supply of a certain market segment, i.e. the cross-price elasticity of demand of products P₁, P₂, and P₃ is positive and—dependent on the uniqueness of the invention protected by patent 10—between 0 and 1. The cross-price elasticity of two products is a measure on how much the sales of the first product increase (decrease) if the price for the second product is reduced (heightened). If the uniqueness of the protected invention is very low, i.e. if the added value for the demand is negligible, the cross-price elasticity of demand will be close to 1.

As P₁ is protected by patent 10, only assignee 14 of the patent 10 has the right to bring the product P₁ to market. Assignee 14 could, for instance, be enterprise E₁. Alternatively, assignee 14 could have issued a license to one or more enterprises. Either way, it is assumed that the subject matter protected by patent 10 generates some added value for the consumers, i.e. demand 13. Thus, every enterprise being a supplier of the respective market would be interested in having the patent 10 in order to incorporate the at least one essential attribute of the patent into their product, thus gaining an advantage in the market.

Theoretically, market oriented patent valuation methods in the state of the art aim at gaining market value information on the patent market 16 such as the demand for the patent or typical license fees. However, the present invention proposes another way of market valuation by examining the patent related product market 15. In order to value patent 10, the demand for the essential attribute(s) of the protected invention is estimated. Hence, although the demand 13 is, in general, not interested in the patent 10 itself, a sample set 11 of the demand 13 is chosen and interviewed in order to valuate the patent 10. The sample set can be chosen randomly or systematically. Either way, sample set 11 should be a representative subset of the set 13 of demanders. If there is only a very small demand, e.g. if patent 10 protects an essential attribute of a manufacturing machine with only a few manufacturers being active in this market, sample set 11 and demand 13 can be identical. In general, however, there are only between fifty and a few hundred people interviewed whereas there are thousands or even millions of possible demanders. Here and in the following, the term “demander” and “consumer” are used as synonyms.

Whereas FIG. 1 shows the basic steps for performing the present invention and FIG. 2 shows the concept underlying the present invention, the following figures will show exemplary embodiments of the present invention. This should not, however, be interpreted as if other embodiments were excluded from the scope of invention. The described embodiments should rather be regarded solely as examples that show specific ways of performing the method according to the present invention.

FIG. 3 shows a typical embodiment of steps for identifying the at least one essential attribute of the subject matter of the IPRoA. Here and in the following, the IPRoA is assumed to be a patent. Dependent on the complexity of the claim language, a feature analysis of the at least one independent claim of the patent may be undertaken in step 201. In the case of simple claim language, this step may be unnecessary and can be omitted.

In further step 202, a search for the related state of the art is undertaken. The sources of information can be: Documents cited in the patent, documents cited by the Patent Office during examination, data bases, scientific publications, market and competitor analysis etc. The purpose of the state of the art search is manifold.

Firstly, it helps identify the at least one essential attribute of the patent's substantial matter (step 203). Those attributes which are well known in the state of the art are typically not the essential attributes of the invention. Typically, the essential attribute of the invention is the one that is unknown in the state of the art whereas the expression “an attribute is unknown in the state of the art” is to be understood as “an attribute is unknown in the state of the art in the given combination”. Secondly, a state of the art search helps identify other attributes which are relevant for consumers of the patent related product/method. This issue will be resumed below. Thirdly, a state of the art search helps identify the scope of protection of the patent. Fourthly, a state of the art search may reveal other valid IPR with their protection scope overlapping or completely covering the protection scope of the patent to be valued.

In general, the IPRoA language, in particular patent or utility patent claim language, is rather technical and abstract. There are cases wherein the claim language can directly be taken for interviewing respondents about their utility for the respective attributes. In this case, the at least one essential feature of the claim can be chosen as the at least one essential attribute of the subject matter. In general, however, consumers of the patent related product would not understand the at least one essential attribute of the patent if it was presented to them in an interview as the original claim feature. There are, however, different possibilities in order to help the respondents from the sample 11 understand the at least one essential attribute of the patent's subject matter:
1. The essential claim feature is mapped into common speech. Thereby, abstract expressions are replaced by terms which will be understood by the persons interviewed. For instance, abstract expressions could be replaced by way of giving examples or analogies. For example, the term “means for fixing” could, dependent on the invention, be replaced with adequate examples such as “screws, bolts, nails etc.”
2. The essential claim feature is mapped into a functional attribute. For instance, a material for manufacturing an apparatus in the state of the art comprises substance A, resulting in a certain breaking strength of the apparatus. The invention of the patent to be valued proposes the use of substance B instead of A, resulting in a higher breaking strength of the apparatus. Most generally, the users of the apparatus, particularly the persons to be interviewed when undertaking the market analysis 3, do not recognize the effect of replacing substance A by substance B. Hence, it would be no use to address the market analysis to the apparatus' substances themselves. However, the users do understand the function of the new substance B, i.e. the increase of the breaking strength. Thus, the functional attribute “breaking strength” could be identified as the essential attribute and be the object of the market analysis 3.
3. The essential claim feature is mapped into an advantage attribute. The example given under item 2 shall be resumed. For instance, the apparatus having the material comprising substance A could have a mean life-time of seven years whereas the apparatus comprising substance B could have a mean life-time of twelve years due to the increased breaking strength. The prolonged life-time is an advantage every user of the respective apparatus will understand and appreciate. Hence, the advantage attribute “life-time” could be identified as the essential attribute and be the object of the market analysis 3.

It depends on the specific IPRoA to be valuated if the person, who performs the valuation, decides to undertake a claim language mapping and, in this case, how much of a mapping of the at least one essential attribute is useful (steps 204 and 205 in FIG. 3). Typically, the simpler the claim language and/or the more skilled the persons to be interviewed, the less mapping must be undertaken. On the other hand, the more difficult the claim language and/or the less skilled the persons to be interviewed, the more it is advisable to map the claim attribute(s) into functional or advantage attribute(s). In the following and in FIG. 3, the term “CU-attribute(s)” refers to “consumer understandable attribute(s)”. That is, as a result of the steps for identifying the at least one essential attribute of the subject matter of the patent, the attribute(s) identified shall be understandable by the respective demanders to be interrogated and shall directly relate to the essential attribute(s) of the invention and the essential features of the claims. Hence, the essential attributes(s) can be claim language features, or claim features which have been translated into common speech, or they can be functional attributes or advantage attributes.

FIG. 4 shows a typical embodiment of steps for undertaking a market analysis in order to valuate the IPRoA. Here and in the following, the IPRoA is assumed to be a patent. The market research aims at gaining information on how much added value the persons have when owning the patent related product instead of competitor products which do not comprise the essential attribute(s) of the patent to be valuated. People buying a product that generates an added value agree on paying an added price for this product. It is the object of the market analysis to get information on the added value distribution of the sample set 11 of the respective demand market 13. From the added value distribution, a price-response function of the essential attribute(s) can be derived.

Therefore, a survey is undertaken which particularly addresses the at least one essential attribute of the patent's subject matter. Typically, the survey asks for the respondent's preferences for different objects. These objects can be the essential attribute(s) of the invention and their related attributes from the state of the art. In the apparatus example given above, the survey could examine people's preference for apparatuses with life-times of five, seven and twelve years. The longer the life-time is, the more preferred it is, in general, the respective product. The survey aims at quantifying this preference in terms of utility values. That is, the steps described here and below aim at giving answers to the following exemplary questions: How much is a twelve year life-time apparatus more preferred than a seven year life-time apparatus? What is the utility of the twelve year life-time apparatus in comparison to the utility of the seven year life-time apparatus for the consumers? What additional price do consumers agree to pay in order to get the twelve year life-time apparatus instead of the seven year life-time apparatus?

The latter question can, for instance, be solved by asking the survey respondents directly for their added price that they would pay in order to have the twelve year life-time apparatus instead of the seven year life-time apparatus. That is, the respondents would have to express their preference for the essential attribute(s) of the invention in comparison to the respective attributes from the state of the art directly, by specifying an added price. Market analysis methods like this are called compositional methods.

In a typical embodiment of the present invention, the method for interrogating the respondents is a decompositional method. Decompositional methods are characterized in that they do not ask for isolated attributes of an object, such as the price or the life-time, but the whole object. Examples of decompositional methods are (classical) Conjoint Analysis (CA), hybrid CA, customized CA, computerized CA models etc. In the following, the patent valuation of the present embodiment is undertaken by conducting a classical conjoint analysis. However, this is to be understood solely as an example as other decompositional methods known in the state of the art could also be applied.

CA is one of the terms used to describe a broad range of techniques for estimating the value people place on attributes and options which define products and services/methods. Discrete Choice, Choice Modelling, Hierarchical Choice, Card Sorts, Trade-off Matrices, Preference Based Conjoint and Pairwise Comparisons are various forms of the CA which can be applied when valuating an IPRoA. Instead of CA, the term Conjoint Measurement is also very common. In the following, a very short introduction into CA is given.

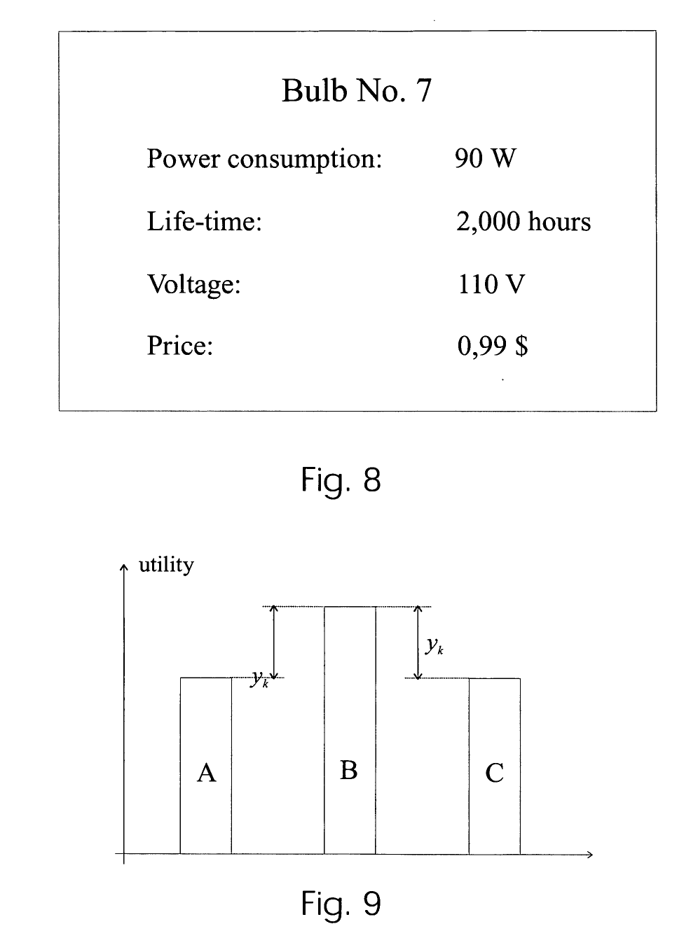

The goal of the CA is to assign specific utility values to the options that consumers consider when choosing between concurring products and making a purchase decision. For instance, a traditional bulb could be specified by the attributes power consumption, life-time, voltage and price. Different options are assigned to each attribute, e.g. 40 W, 60 W or 90 W to the power consumption attribute; 1,000 hours, 2,000 hours and 5,000 hours to the life-time attribute etc. When searching for information on the preference of consumers, random combinations, i.e. the so called “stimuli”, with one option of each attribute are presented to the respondents of the CA interviews. According to a typical CA interview, the respondents rank the stimuli presented according to their preference. For instance, the respondents are given ten stimuli, each describing a bulb by means of specifying one option for each of the attributes power consumption, life-time, mount size and price. An exemplarily bulb stimulus is shown in FIG. 8. Then, the respondents have to arrange these stimuli in an order that reflects their preference for the bulbs described on the stimuli. For instance, the respondents could place the most preferred stimulus (i.e. the most preferred bulb) on the top of the stimuli stack, whereas the least preferred stimulus (i.e. the least preferred bulb) could be placed as the lowest. This method is the so-called “ranking method”.

Alternatively, the respondents assign a unique number to each stimulus with the largest number (i.e. the total number of stimuli presented) being the most (least) preferred and number 1 being the least (most) preferred. Alternatively, according to the so-called “rating-method”, every stimulus is assigned a number between e.g. 1 (i.e. “would not buy it”, or “uninteresting product”) and 5 (i.e. “would buy it”, or “great product”). According to an alternative embodiment, according to the so-called “constant-sum method”, a given amount of points can be distributed to the several stimuli with the most points being distributed to the most preferred product. Alternatively, according to the so-called “dollar-metric”, a price is assigned to each stimulus with the price being respondent's reserve price for the whole product of the stimulus. The latter method renders the inclusion of the price attribute into the CA unnecessary. However, for the respondents it is the most difficult task.

When designing a CA for IPRoA valuation (step 301), one has to find adequate CA attributes and options. In general, it is advisable that none of the attributes and options is a so-called k.o. criterion which cannot be compensated by other attributes' options. Furthermore, it is advisable that there are not too much attributes and options as otherwise there are too many stimuli to be rated by the respondents. This would overburden the respondents and lead to unreliable results of the CA interviews. Typically, it is advisable to have less than 5-6 attributes and less than 4-5 options. When valuating a patent, the essential attribute(s) of the invention protected by the patent must be part of the CA. As already described above, the respondents should understand the attributes and options presented on the stimuli. Otherwise, unreliable results are achieved. Therefore, regarding the patent related attributes and options, the above-described CU-attributes are chosen for the CA. Typically, the CA comprises the price as one attribute and other attributes, which are relevant for the consumer decision to buy the respective product. These other attributes are typically not protected by the patent to be valuated.

The essential attribute(s) of the patent's subject matter are mapped into CA attributes and options, as already described above. In general, three cases can be distinguished which are explained by means of examples for a better understanding in the following. However, it is highlighted that these examples shall not be deemed as narrowing the scope of invention.

In the first case, the essential attribute(s) are mapped into one CA attribute with the two options “existing” and “not existing” (or the like). For instance, let the patent's subject matter be an airbag for a child car seat. In order to valuate this patent with the method according to the present invention, a market analysis on child car seats is undertaken. If it is undertaken by way of a CA, one attribute of the CA will be “airbag” with the two options “existing” and “not existing”. The option “existing” relates to the patent to be valuated whereas the option “not existing” relates to non-protected state of the art.

In the second case, the essential attribute(s) of the patent's subject matter are mapped into one or more options of one CA attribute whereas at least one option is not related to the patent. In the bulb example given above, the life-time of 5,000 hours could be one option of the CA attribute “life-time” and would relate to the patent whereas the other two life-times options of 1,000 hours and 2,000 hours relate to the state of the art. Alternatively, two life-time options, e.g. 5,000 hours and 6,000 hours, could relate to the patent, whereas shorter life-times relate to the state of the art.

In the third case, the essential attribute(s) of the IPRoA's subject matter is/are mapped into one or more options of different attributes of the CA. This case is typically relevant if the essential attribute(s) of the invention is/are mapped into functional or advantage attributes of the CA. For instance, the new bulb technique could result in both a longer life-time and reduced power consumption. Hence, in this example, at least one option of each attribute “life-time” and “power consumption” of the CA would relate to the patent to be valuated.

In all cases, the CA or the other market analysis method applied contains at least one option of a CA attribute, whereas said option is related to the IPRoA. Furthermore, the CA attribute having the IPRoA related option must have at least one option that is not protected by the IPRoA to be valued. This will become more evident below.

Typically, once the attributes and options are chosen, a statistics software such as SPSS™ (see www.spss.com) or stata™ (see www.stata.com) takes over the task of generating the stimuli. As, in general, every possible combination of options would result in too many stimuli, a certain subset of possible combinations must be elected. Typically, this subset is the so-called “orthogonal design” which can be provided by the statistics software. In general, the subset comprises between 9 and 25 stimuli. Too few stimuli do not allow statistically valid statements on the whole set whereas too many stimuli overburden the respondents, which in turn leads to invalid results of the patent valuation.

In addition to the stimuli necessary for preference estimation, so-called “hold-out” stimuli can be provided. The hold-out stimuli are presented to the respondents together with the stimuli from the orthogonal design. However, they are not used for utility value estimation but for an internal validity check of the utility estimation results of the CA. Typically, 1-3 hold-out stimuli are advisable for IPRoA valuation.

In step 302 of the exemplary embodiment shown in FIG. 4, a sample subset of the consumers is elected. The sample subset can be elected randomly, e.g. by fetching every n-th person in an adequate department of a big store. For instance, if the patent is related to dish washers, the interviews could take place in the household department. Thus the respondents belong to the consumers of household equipment. Typically, the interviewer asks a filter question such as “would you, in general, consider buying a dish washer?” Alternative to the random sample, the sample subset could be elected according to the quota sample procedure aiming at a perfect representative sample subset. Other techniques for electing a representative subset of consumers are known in the state of the art.

The whole set of stimuli, i.e. the orthogonal design and the hold-out stimuli, are presented to the elected representative sample subset of consumers in step 303. The respondents have to judge on the stimuli as described above. Typically, it is the respondent's job to rank the stimuli in an order that corresponds to their preferences for the respective stimuli.

Whatever method of judgement is chosen, the interviewer has to specify the method in the statistics software when entering the results. For instance, if the ranking method is chosen, the results are entered into the software in the form of a table with the first column designating the number of the respondent and the following columns designating the ranking order of the stimuli. Then, in step 304, the software computes the individual utility values for every respondent and every option of every attribute. Typically, these values are not yet standardized.

In this case, it is necessary to standardize the utility values computed. Only a standardized individual utility value is comparable with another individual utility value. Let uₖ(aᵢⱼ)refer to the utility of option j of attribute i of given respondent k. Further, let attribute i have Sᵢ options. First of all, the utility of every option is aligned to zero, i.e. the value 0 is assigned to the utility of this option which is least preferred. This is done for every attribute i. That is, the following transformation is performed for every attribute i and every option j=1, . . . , Sᵢ:
u(aᵢⱼ)→u(aᵢⱼ):=u(aᵢⱼ−_{l=1, . . . ,S}ᵢ^{min} u(aᵢⱼ)

Then, the utilities of the options are standardized in such a way that the utility of the combination of each most preferred option is set to 1. That is, the perfect combination, independent on if there was a stimulus representing this combination or not, is set to have the utility of 1. Let M denote the total number of attributes of the CA, then the following transformation is performed:

$$u * ( {a}_{ij} ) -> \hat{u} ( {a}_{ij} ) := \frac{u * ( {a}_{ij} )}{{\sum }_{k = 1}^{M} {max}_{l = 1 , … , {S}_{k}} u * ( {a}_{kl} )}$$

In the following, the hat on u(aᵢⱼ) is, for convenience, omitted and u(aᵢⱼ) refers to the standardized utility of option j of attribute i.

If the described standardization is performed for every option, the utility of each option is comparable to other utilities. Furthermore, according to a condition of the CA, a low utility of option j of attribute i can be compensated by a high utility of another option l of another attribute k≠i. In particular, a stimulus having a larger price may be as preferred as another stimulus with a lower price if it has an option that brings some other added value. For instance, a bulb with 1,000 hours life-time at a price of $0.99 may have the same utility value (i.e., it is as preferred) as a bulb with 3,000 hours life-time at a price of $2.99.

When valuating IPRoA with the method according to the present invention, it is an object to find out what additional price the respondents agree to pay in order to have the essential attribute(s) of the invention of the IPRoA. The maximum price at which they would still buy the product having the essential attribute(s) is called the reserve price for the essential attribute(s). If the essential attribute(s) of the IPRoA to be valuated are offered at a price higher than the respondent's reserve price, the respective respondent would not buy it.

Let k denote the respondent and Δₖ the reserve price of respondent k for the essential attribute(s) of the invention of the IPRoA. Without loss of generality, let aₗ₁ be the option of the CA that relates to the essential attribute(s) of the invention of the IPRoA. The other options aᵢⱼ, j=2, . . . , Sₗ, of attribute l are not protected by the IPRoA in question. For instance, the invention could address a bulb with an increased life-time of 6,000 hours, whereas the best traditional bulb has a life-time of 3,000 hours. In this case, aₗ₁ would be 6,000 hours. As alternative options of the CA attribute “life-time”, one could choose, for instance, aₗ₂ to represent 3,000 hours and aₗ₃ to represent 2,000 hours. The alternative non-protected options should be realistic and chosen from the related state of the art. If the alternative options are unrealistically bad (e.g. a life-time of 100 hours in the bulb example), the value of the IPRoA is overestimated.

Hence, in the example given, there are three options of the attribute “life-time”. In this example, it is quite clear that the utility for longer life-times is, in general, higher, i.e. u(aₗ₁)>u(aₗ₂)>u(aₗ₃). However, in other examples, the IPRoA related option may be preferred by some respondents whereas other respondents prefer an option from the state of the art (see snorkel example below). In order to quantify the preference for the IPRoA related option, the utility u(aₗ₁) of the IPRoA related option is compared to the utility of the most preferred unprotected option:

$${y}_{k} := {u}_{k} ( {a}_{l 1} ) - {max}_{j = 2 , … , {S}_{l}} {u}_{k} ( {a}_{lj} )$$

The Index k refers, as above, to the respondent k, and Sₗ is the number of options of the attribute l. Let yₖ be named “added utility” of the essential attribute(s); it can be positive or negative. Only if yₖ is positive, respondent k prefers the option protected by the IPRoA in question.

The utility of the CA price attribute is typically linear with a larger price generating less utility. Hence, the respondent's k utility function uₖ(p) of the attribute price p is of the form:
uₖ(p)=αₖ−βₖ·p

αₖ denotes the utility of the $0 price. However, as in the following only price differences are calculated, αₖ is not of interest. The linearity constant βₖ is, in general, positive. The larger βₖ is, the more price sensitive is respondent k and the smaller becomes the utility uₖ(p) of the price attribute with larger prices p. Consequently, for a highly price sensitive respondent, the utility of a very small price becomes very high.

In order to derive the individual reserve prices for the essential attribute(s) of the IPRoA's subject matter, a price, e.g. a dollar amount, is assigned to the added utility of the essential attribute(s) of the patent's subject matter. As long as, for a given respondent, the added utility which stems from having the protected option aₗ₁ is larger than or equal to the negative utility which stems from an increased price, respondent k would still buy the product which offers the IPRoA related essential attribute(s). The maximum price that respondent k would agree to pay is the response price Δpₖ. The reserve price Δpₖ of respondent k is defined as the threshold value:

$${y}_{k} = {u}_{k} ( p ) - {u}_{k} ( p + Δ {p}_{k } ) \\ ⇔ {y}_{k} = - {β}_{k} p + {β}_{k} p + {β}_{k} Δ {p}_{k} \\ ⇔ Δ {p}_{k} = \frac{{y}_{k}}{{β}_{k}}$$

Hence, step 401, shown in FIG. 4, is performed. That is, for every respondent k a reserve price Δpₖ for the essential attribute(s) of the invention is calculated.

FIG. 9 illustrates the above derived relationship in view of an example. A, B and C refer to the total utilities of three different option combinations. Utility A refers to a combination with price p and unprotected option aₗ₂. As in the example above, option aₗ₂ relates to the IPRoA's subject matter whereas option aₗ₂ (and, if existing, further options aᵢⱼ, j=2, . . . , Sₗ relates to unprotected options, i.e. options which are not covered by the IPRoA's protection scope. Utility B refers to a combination with the price p and the protected option aₗ₁. That is, the utility of the respondent in question for the IPRoA related option is at the added value yₖ higher than for the best unprotected option (in this example, all utilities stemming from the other options are held constant). Utility C refers to a combination with the price p+Δp and the protected option aₗ₁. As it can be seen, the utility C is the same as the utility A although the price of the combination is at Δp higher. That is, the respondent in question has a higher overall utility for a combination with price p+Δp and the protected option aₗ₁ than for the combination with price p and unprotected option e.g. aₗ₂ as long as the negative utility stemming from the additional price Δp is smaller than yₖ.

The next step 402 is deriving an individual price-response function. There are only two possible values in an individual price-response function for the at least one essential attribute(s) of the IPRoA's subject matter: That is the value 1 up to the reserve price Δpₖ, as respondent k would want to have the essential attribute(s) at a price smaller than the reserve price, and that is the value 0 for prices larger than the reserve price. For convenience, this relation shall be defined by the following function:

$$\hat{Θ} \text{(} p - Δ {p}_{k} := \{ \begin{matrix}1 if p \leq Δ {p}_{k} \\ 0 if p > Δ {p}_{k}\end{matrix} .$$

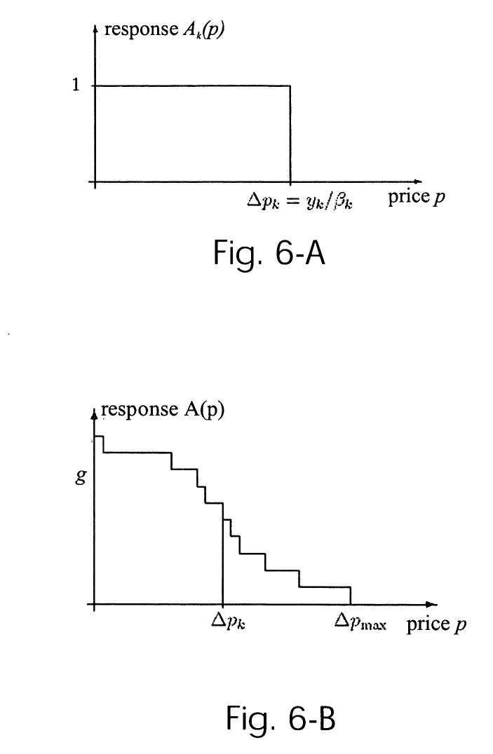

An exemplary price-response function for respondent k is shown in FIG. 6-A. It shall be highlighted that the individual price-response function Aₖ(p) refers only to the essential attribute(s) of the IPRoA which is/are subject to the market analysis. The individual price-response function Aₖ(p) does not relate to the respective whole product or method.

Hence, the individual price-response function Aₖ(p) for respondent k shown in FIG. 6-A can be written as:
Aₖ(p)=\hat{Θ}(p−Δpₖ)

In step 403, the price-response functions of all respondents are added. For valuating IPRoA, the number of persons who are interested in the essential attribute(s) is of interest. Let g denote the number of people belonging to the relevant market segment, and let n be the number of respondents interviewed. For instance, if the invention is addressed to an alarm system for cyclometers, the relevant market segment could be the people owning a cyclometer. Hence, g would stand for the number of cyclometer owners whereas n refers to the number of cyclometer owners who are interviewed in the framework of the IPRoA valuation market analysis. The common price-response function A(p) is as follows:

$$A ( p ) = \frac{g}{n} {\sum }_{k = 1}^{b} \hat{Θ} ( p - Δ {p}_{k} ) \qquad ( 1 )$$

An exemplary price-response function A(p) is shown in FIG. 6-B with n=10. This is for demonstration purposes only; typically, n is larger than or equal to 50, or larger than or equal to 100. The interpretation of the exemplary price-response function A(p) of FIG. 6-B is as follows: If the essential attribute(s) of the invention protected by the IPRoA to be valued costs more than Δpₘₐₓ, none of the respondents would want to have it. At a price of Δpₘₐₓ, only one respondent wants to have it. At the exemplarily shown price Δpₖ, six of the ten respondents would want to have it and so on. A(p)'s maximum (i.e. value g) could also be at a negative price. In this case, at least one respondent prefers to have an alternative option which is not covered by the IPRoA instead of the IPRoA related option.

The more respondents are interviewed, the smoother becomes the function. The number of respondents n depends on the situation. However, n has to be chosen such that the answers of the respondents must be interpretable as a market reaction. In other words, the n respondents must be chosen such that they represent sufficiently well the whole set of relevant consumers.

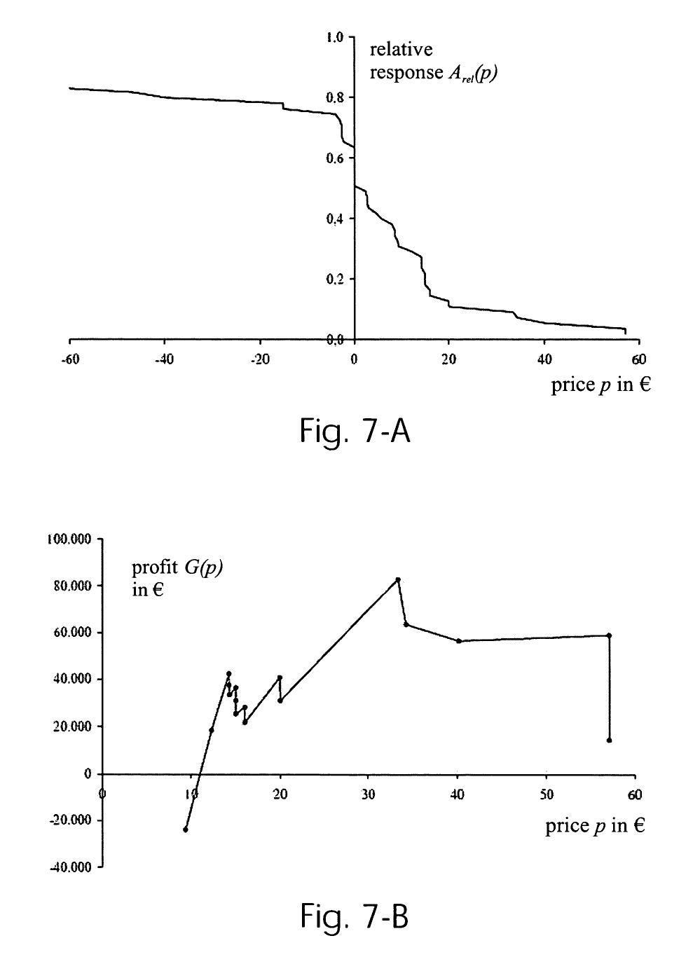

FIG. 7-A shows another example of a common price-response function. The price-response function is illustrated as relative price-response function Aᵣₑₗ(p), that is, the total market size g is omitted in the calculation. This price-response function was measured when valuating a patent about a specific snorkel with n=55 respondents. The snorkel protected by the patent offers the possibility to listen to music via the mouth piece without the need for head sets. The function of FIG. 7-B gives an example for the fact that not every respondent is fond of the invention covered by the patent to be valued: About one third of the people show to have a negative reserve price for the mouth piece of the invention, i.e. they prefer to have a conventional snorkel mouth piece instead of the mouth piece according to the patent's subject matter which is suitable for transmitting music to the snorkel diver via his/her teeth.

Step 404 is to derive a price-sales function for the at least one essential attribute of the invention protected by the patent to be valued. It shall be highlighted that it is not the whole product which is subject of the price-sales function, but only the essential attribute(s) of the patent's subject matter. The price-sales function shall be labeled U(p) and is defined as the product of price p and response A(p):

$$U ( p ) = \frac{g}{n} {\sum }_{k = 1}^{n} p \cdot \hat{Θ} ( p - Δ {p}_{k} )$$

In order to calculate a price-profit function in step 405, costs must be considered. Typically, costs are divided into fixed costs K_{f} and variable costs. In a typical approach, the variable costs are linear with respect to the sales quantity A, that is, the variable costs constant Kᵥ defines how much the production of one additional product costs. Hence, let K(A) denote the cost function which is typically defined as follows:
K(A)=K_{f}+Kᵥ·A

Since the profit function is defined as the difference between sales function and cost function, the cost function is needed to be dependent on the price p instead of the sales quantity A. Hence, first of all, equation (1) is used to transform the cost function into a cost function which is dependent on the price:

$$K ( p ) = {K}_{f} + {K}_{v} \frac{g}{n} {\sum }_{k = 1}^{n} \hat{Θ} ( p - Δ {p}_{k} )$$

Examples for costs to be considered comprise: IPRoA related costs such as annuities, translations costs, patent attorney costs, examination fees etc.; production costs for the essential attribute(s) whereas only the additional costs for producing the IPRoA related essential attribute(s) must be considered; license fees; marketing costs etc. The cost function refers, as the price-response function, price-sales function and the below introduced price-profit function, only to the costs of the at least one essential attribute of the IPRoA's subject matter and does not involve other costs.

In step 405, the price-profit function is derived which is defined as the difference between sales function (first term in the following equation) and cost function (large brackets in the following equation), and which is labeled G(p):

$$\begin{matrix}G ( p ) = \frac{g}{n} {\sum }_{k = 1}^{n} p \cdot \hat{Θ} ( p - Δ {p}_{k} ) - ( {K}_{f} + {K}_{v} \frac{g}{n} {\sum }_{k = 1}^{n} \hat{Θ} ( p - Δ {p}_{k} ) ) \\ = \frac{g}{n} ( p - {K}_{v} ) {\sum }_{k = 1}^{n} \hat{Θ} ( p - Δ {p}_{k} ) - {K}_{f}\end{matrix} \qquad ( 2 )$$

It shall be—once again—highlighted that the price-profit function G(p), as the price-response function A(p) and price-sales function U(p), refers to the essential attribute(s) of the invention only. G(p) addresses the relation between price for the essential attribute(s) and achievable profit with the essential attribute(s). It does not allow for any inference on the achievable profit with the respective whole product which has the essential attribute(s). The present invention only considers the additional profit caused by the IPRoA to be valuated and does not examine the profit of any related product.

An exemplary price-profit function of the snorkel example introduced above is shown in FIG. 7-B. The function is not shown for negative profits as only positive profits are of interest. In this example, the maximum profit with the snorkel mouth piece according to the invention of the patent can be achieved at a price of 33.40 ε (that is the price of the snorkel mouth piece and not of the whole snorkel). In this case, 5/55≈9% of the snorkel demanders would purchase a snorkel having the mouth piece according to the patent's subject matter.

In step 406, the maximum of G(p) is calculated. Therefore, the individual reserve prices Δpₖ are rearranged in a descending order such that they fulfill the following condition:
Δpₖ≦Δpₖ₋₁∀k=2, . . . , n.

This way, equation (2) can be written as the following piecewise continuous function:

$$G ( p ) = \frac{g}{n} k ( p - {K}_{v} ) - {K}_{f}$$

$$for$$

$$Δ {p}_{k + 1} < p \leq Δ {p}_{k} , \\ k = 1 , … , n .$$

This is because G(p) is piecewise linear with the term

$${\sum }_{k}^{n} \hat{Θ} ( p - Δ {p}_{k} )$$

being constant in each interval Δpₖ₊₁<P<ΔPₖ, k=1, . . . , n. As G(p) is strictly monotonic increasing in each piecewise linear interval, for determining the maximum of G(p), it is sufficient to compare the respective largest value of all intervals. The respective largest value is at the discontinuity positions Δpₖ, k=1, . . . , n, of G(p). Hence, the profit maximum Gₘₐₓ with the essential attribute(s) of the IPRoA to be valuated is:

$${G}_{max} = G ( {p}^{*} ) = \frac{g}{n} \cdot {{}^{max}}_{k = 1 , … , n} \{ k ( Δ {p}_{k} - {K}_{v} ) \} - {K}_{f}$$

The price p* shall be named “profit optimum price” as at this price the profit with the at least one attribute of the IPRoA is maximal. In the case of negligible costs, i.e. Kᵥ≈0 and K_{f}≈0, this equation simplifies to:

$${G}_{max} = \frac{g}{n} \cdot {{}^{max}}_{k = 1 , … , n} \{ k \cdot Δ {p}_{k} \}$$

The profit maximum Gₘₐₓ can, in a first-order approximation embodiment, be understood as the value of the IPRoA. This approximation is based on the following two considerations:

Firstly, a person who is interested in the IPRoA related product, and buys it once, does not buy it again. In other words, the demand for the product becomes entirely exhausted once it is purchased. This assumption is true for capital goods in most cases, and inventions from IPRoA are, in most cases, directed to capital goods.

Secondly, the situation of having the IPRoA results in gaining this profit maximum to the exterior of competition. When calculating the IPRoA value according to the present invention, this situation has to be compared with the situation of not having the IPRoA. Not having the IPRoA can stand for: Either a competitor has the IPRoA, or there is no protection at all. In the first case, for the non-IPRoA-holder, it is not allowed to offer a product having the essential attribute. Hence, the gained profit with the essential attribute of the invention is zero. That is, the comparison of the situations still leads to Gₘₐₓ as the IPRoA value. The second case, however, is a bit more complicated. Typically, if there is no patent protection, free competition regarding the product/method having the essential feature(s) evolves. During the short period of competition evolvement, prices keep falling until they reach, under perfect competition situation, the lowest possible price which is identical to the marginal cost of production. If there were no diversification possibilities for the vendors, such as brand loyalty or the like, they would not gain any profit from selling the product/method with the essential attribute any more. Hence, in a comparison with the situation of a non-protected invention, one has to realize that, in the middle- and long-term, there are no profits any more which stem solely from the essential attribute(s) of the invention. Hence, in an approximation, this situation leads also to the gain of zero and, thus, to the IPRoA value of Gₘₐₓ.

In another embodiment of the present invention, the Gₘₐₓ equations given above can be used for another value determination. Let g not be understood as total market size of the relevant market segment but as the achievable sales quantity per time unit in this market segment. For instance, in the snorkel example given above, it was assumed that 100,000 snorkels per year are sold in Germany, that is g=100,000 sales/year. With g like this, Gₘₐₓ becomes the maximum profit per year. For determining the total profit achievable due to the IPRoA, the maximum profits of the following years must be considered. It is necessary to discount future profits with an appropriate interest rate j and it is necessary to determine the number N of subsequent years that shall be considered. For instance, N could be defined as the maximum life-time of the patent, utility model, or design model in question. However, forecasts for more than 10 or 15 years are, in general, difficult to work out. Hence, as general advice, N should relate to a period which is realistically predictable and, in general, N must not excess the remaining life-time of the patent.

In addition, according to one embodiment of the present invention, in order to provide for effects stemming from the position of the IPRoA related product in its product life cycle and/or technology life cycle, the life-cycle function ƒ(t) may be introduced when valuating IPRoA. The life cycle function ƒ(t) modulates the demand calculated by means of the above described method, i.e. it is put alongside the above calculated maximum profit Gₘₐₓ. Hence, the value of the IPRoA, which shall be labeled V_{B} henceforth, can be determined as:

$${V}_{B} = {\sum }_{i = 0}^{N} \frac{1}{{( 1 + j )}^{t}} \overbrace{( \frac{g}{n} \cdot f ( t ) \cdot {{}^{max}}_{k = 1 , … , n} \{ k ( Δ {p}_{K} - {K}_{v} ( t ) ) \} - {K}_{f} ( t ) )}^{{G}_{f} ( t ) \text{:} =}$$

The sum together with the fraction is responsible for discounting G_{f}(t), which is the maximum achievable profit at year t with simultaneous consideration of the respective life cycle position, expressed by ƒ(t). For instance, if ƒ(t) is 1 for all t=1, . . . , N then G_{ƒ}(t)=Gₘₐₓ for all t=1, . . . , N. Please note that in this embodiment costs K_{ƒ}(t) and Kᵥ(t) (which are not dependent on the price any more as they are taken at the profit optimum price) can differ in time t. For instance, the fixed costs K_{f}(t) could be very high in the first year(s) due to the necessary change of operation in the production factory whereas they could decrease significantly in later years. Another example stems from the learning curve effect leading to smaller overall costs in later years.

Please note that, once again, the situation of having the IPRoA is compared with the situation of not having it. The patent holder can benefit from the value V_{B}. For the IPRoA non-holder, the profit stemming from solely the essential attribute(s) of the invention, is zero as in this case it is forbidden to incorporate the essential attribute(s) into the respective product/method. If free competition evolves, prices fall until they reach marginal costs of production, resulting in no gain from the essential feature either. That is, the comparison leads to V_{B} as the IPRoA value.

The method for valuating IPRoA according to the present invention allows also the consideration of uncertainty and risks. Such risks comprise legal risks, economic risks and technical risks. The legal risks comprise risk of final rejection; risk of re-examination, risk of opposition or nility action against the IPRoA; risk of denial of a federal allowance (e.g. in the case of pharmaceuticals); risk of dependence on other IPRs etc. The economic risks comprise market dynamics risks in both supply and demand; commercialization risks; risk of scarce resources etc. Examples for technical risks are production problems or integration of the new product production into the processes of the enterprise.

In one embodiment, risks are considered by replacing the maximum profit Gₘₐₓ with its expectation value ε(Gₘₐₓ). In an alternative embodiment, i.e. in the above described case of the valuation by discounting predicted maximal future profits with simultaneous consideration of life cycle effects, the time and life cycle dependent profit G_{ƒ}(t) is replaced with its expectation value:

$$ɛ ( {V}_{B} ) = {\sum }_{t = o}^{N} \frac{ɛ ( {G}_{f} ( t ) )}{{( 1 + j )}^{t}}$$

In dependence on whether a) risk should be considered at all, b) risk is considered separately (see below), or c) risk is considered in the discounting, j refers to the risk-free interest rate (case a) and b)) or j refers to the risk-adjusted interest rate (case c)). The expectation value can, for instance, be calculated by considering alternative situations that each result in an alternative maximum profit with a certain probability of occurrence assigned to each situation. Furthermore, to each alternative situation a proportion factor is assigned, wherein the proportion factor is the relation of the respective maximum profit achievable in the situation and the maximum profit as calculated. For instance, if V refers to the maximum profit, A is a set of alternative situations at a certain period, px is the respective probability of occurrence of situation x∈A, and φₓ is the respective proportion factor, then the expectation value ε_{A}(V) is as follows:

$${ɛ}_{A} ( V ) = {\sum }_{x ∈ A} {p}_{x} {ϕ}_{x} V$$

According to another embodiment of the present invention, a set of IPRoAs, a corporate IP portfolio, such as a corporate patent portfolio, or parts thereof can be valuated whereas the market analysis has to be undertaken only once, and whereas for each member of the set a value is calculated referring only to the value of the respective IPRoA. If the IPRoAs are directed to related art, it is possible to map the respective at least one essential attributes of the various IPRoAs into one joint market analysis. For instance, patent A could refer to the cooling mechanism of a fridge allowing for a highly economic operation of the fridge, patent B could refer to an antibacterial coating of fridge surfaces allowing for an increase of durability of the food stored in the fridge, and patent C could refer to an isolation material allowing for a reduced fridge casing, i.e. an increased inner space. Hence, for a joint valuation of these patents by e.g. conducting a CA, the CA attributes “current consumption”, “antibacterial coating” and “relation of inner to outer space” could be composed. Each CA attribute of the present example has one option relating to the patent. Hence, the values for each patent can be determined in the way described above.

It is to be understood that the above described fridge example is given for illustrating the portfolio valuation in view of an exemplary valuation situation and must not be misinterpreted as narrowing the scope of the invention.

When calculating the value of the set of IPRoA, the values of all IPRoA members may be added by calculating a simple or weighted sum. Dependencies and/or multi-protection of the IPRoAs could also be considered. For instance, the protection scopes of some of the set's IPRoAs may overlap. In this case, for instance, it is possible to reduce the total of the respective IPRoA values by an amount which corresponds to the magnitude of the overlap. According to another embodiment, the overlap of the protection scopes could already be considered when defining the attributes and options of the market analysis.

### CONCLUSION, RAMIFICATIONS, AND SCOPE OF INVENTION

Thus the reader will see that the described method for IPRoA valuation is a highly exact and reliable method which takes both the subject matter of the IPRoA and the market demand for a respondent product or method into consideration. Hence, the method according to the invention allows for a realistic value determination of the IPRoA in question whereas the determined value is in accordance with an economic understanding of the IPRoA value. Furthermore, as already partly described, the method can be integrated into or supplemented by economic techniques such as discounted cash flow calculation, expectation value calculation, real option valuation etc.

While the above description contains many specificities, these should not be construed as limitations on the scope of the invention, but rather as an exemplification of preferred embodiments thereof. Many other variations are possible. Accordingly, the scope of the invention should not be determined by the embodiments illustrated, but by the appended claims and their legal equivalents.

What is claimed is:

1. A method for valuating an intellectual property right or an intellectual property right application, comprising:
providing said intellectual property right or said intellectual property right application, said intellectual property right or said intellectual property right application claiming a subject matter;
identifying at least one essential attribute of said subject matter;
undertaking a market analysis on the demand for said at least one essential attribute of said subject matter, thereby obtaining market analysis results; and
deriving a value of said intellectual property right or said intellectual property right application by evaluating said market analysis results, whereby the situation of having said intellectual property right or said intellectual property right application is compared with the situation of not having said intellectual property right or said intellectual property right application.

2. The method according to claim 1, wherein said market analysis is a decompositional market analysis method for calculating at least one of preferences and utilities.

3. The method according to claim 2, wherein said decompositional market analysis method is a conjoint analysis.

4. The method according to claim 1, wherein said market analysis on the demand for said at least one essential attribute of said subject matter is undertaken in comparison to the demand for related attributes known in the state of the art.

5. The method according to claim 1, wherein identifying at least one essential attribute of said subject matter comprises:
identifying at least one essential claim feature of said subject matter.

6. The method according to claim 5, wherein identifying at least one essential attribute of said subject matter further comprises:
mapping said at least one essential claim feature of said subject matter into at least one essential functional attribute or at least one essential advantage attribute expressing at least one function or advantage of said at least one essential claim feature.

7. The method according to claim 1, wherein identifying at least one essential attribute of said subject matter is identifying two essential attributes of said subject matter.

8. The method according to claim 1, wherein identifying at least one essential attribute of said subject matter comprises:
identifying the state of the art related to said subject matter;
analyzing said state of the art; and
identifying said at least one essential attribute by comparing said subject matter with the state of the art.

9. The method according to claim 1, wherein undertaking said market analysis comprises:
identifying a relevant market related to said subject matter;
designing a survey, wherein said survey is particularly directed to said at least one essential attribute of said subject matter; and
surveying a sample of said relevant market.

10. The method according to claim 9, wherein surveying comprises:
choosing respondents, wherein the entirety of said respondents forms said sample of said relevant market;
presenting stimuli to said respondents; and
having said respondents judged on said stimuli.

11. The method according to claim 1, wherein deriving a value of said intellectual property right or said intellectual property right application comprises:
deriving a price-sales function for said at least one essential attribute;
deriving a price-profit function for said at least one essential attribute; and
identifying an absolute maximum of said price-profit function, wherein said absolute maximum of said price-profit function is at a position of a profit optimum price.

12. The method according to claim 11, wherein said price-profit function is a price-profit function in dependence on periods, and wherein deriving a value of said intellectual property right or said intellectual property right application comprises adding up said absolute maximum of said price-profit function for several periods.

13. The method according to claim 12, further comprising discounting said maximum of said price-profit function with an interest rate.

14. The method according to claim 1, wherein deriving a value of said intellectual property right or said intellectual property right application comprises:
estimating future risks that said intellectual property right or said intellectual property right application underlies by considering alternative future situations;
assigning specific probabilities of occurrence and a proportion factor to each of said alternative situations; and
considering said estimated future risk when deriving said value of said intellectual property right or said intellectual property right application.

15. The method according to claim 1, wherein said intellectual property right or intellectual property right application is a patent or an application for a patent.

16. The method according to claim 1, wherein said intellectual property right or intellectual property right application is a utility patent or an application for a utility patent.

17. A method for valuating an intellectual property right portfolio, comprising:
providing said intellectual property right portfolio by providing a set of rights selected from at least one of intellectual property rights and intellectual property right applications, each intellectual property right and intellectual property right application from said set claiming a subject matter;
for each of said intellectual property rights and intellectual property right applications: identifying at least one essential attribute of said subject matter; undertaking a joint market analysis on the demand for all of said at least one utilities of said subject matters, obtaining market analysis results; and
deriving a value of each of said intellectual property rights and intellectual property right applications by evaluating the market analysis results, whereby the situation of having each of said intellectual property rights or intellectual property right applications is compared with the situation of not having each intellectual property right or intellectual property right application.

18. The method according to claim 17, further comprising:
deriving a value for said intellectual property right portfolio by adding up said values for each of said intellectual property rights and intellectual property right applications, wherein at least one of dependencies and multi-protection is considered.

19. The method according to claim 17, wherein each of said subject matters refer to different aspects of an apparatus or a method.
